(19) United States
(12) Patent Application Publication
(10) Pub. No.: US 2016/0235155 A1
(43) Pub. Date: Aug. 18, 2016

(54) BEVELED EDGE MATERIAL

(71) Applicant: Applied FT Composite Solutions Inc., Las Vegas, NV (US)

(72) Inventor: Daniel Kim, Busan (KR)

(21) Appl. No.: 14/748,110

(22) Filed: Jun. 23, 2015

Related U.S. Application Data
(60) Provisional application No. 62/117,885, filed on Feb. 18, 2015.

(51) Int. Cl. A43B 7/14; B26D 3/00; B26D 7/14

(52) U.S. Cl. CPC A43B 7/1405; B26D 7/14; B26D 3/003

(57) ABSTRACT

The present application discloses a pad structure that includes a stretchable cuttable material with beveled edge.

### SUMMARY OF THE INVENTION

In one embodiment, the present invention is directed to a pad structure comprising stretchable cuttable material with beveled edge. The beveled edge may be present around the entire material. The structure may be a shoe component.

In another embodiment, the present invention is directed to a system of components comprising: a defecting device on a surface; a sheet of stretchable cuttable material placed on the defecting device on a surface; a cutter having a surface and at least one cutting element extending from the surface in a predetermined pattern, where each cutting element has a shape defining an internal space, and the internal space may be optionally filled with biasing material. The cutting element may be positioned substantially perpendicular to the surface of the cutter from which the cutting element extends. The surface of the cutter from which the cutting element extends may or may not be flat.

In another embodiment, the invention is directed to a method for fabricating a stretchable cuttable material with a beveled edge, comprising: (a) placing a defecting device on a surface; (b) mounting a stretchable cuttable material on the defecting device; (c) providing a cutter having a surface and at least one cutting element extending from the surface in a predetermined pattern, where each cutting element has a shape defining an internal space, and the internal space is optionally filled with biasing material; (d) pressing the cutter into the sheet of stretchable cuttable material, thereby creating a curvature or defect on the stretchable cuttable material formed around the defecting device to form a curved or defected material, and the cutting edge cuts through the curved material thereby forming a cut sheet of stretchable cuttable material comprising a stretchable cuttable material with beveled edge and an excess of stretchable cuttable material, where each stretchable cuttable material with beveled edge has a shape corresponding to the shape of the internal space of its corresponding cutting element; (e) withdrawing the cutter from the cut sheet of stretchable cuttable material, thereby leaving the cut sheet of stretchable cuttable material with the cut portions of the stretchable cuttable material with beveled edge surrounded by the excess stretchable cuttable material; and (f) removing the stretchable cuttable material with beveled edge. The cutting edge blade may be angled substantially perpendicular to the surface. The curvature or defect on the sheet of stretchable and cuttable material may be increased by increasing the curvature of the defecting device. The surface of the cutter from which the cutting element extends may or may not be flat.

### BRIEF DESCRIPTION OF THE DRAWINGS

The present invention will become more fully understood from the detailed description given herein below, and the accompanying drawings which are given by way of illustration only, and thus are not limitative of the present invention, and wherein;

FIG. 1A is a drawing of the apparatus system to carry out the method of the invention.

FIG. 1B is a drawing of the apparatus system to carry out the method of the invention.

FIG. 2 is a view of the cutter.

FIG. 3 is a view of the cutter.

FIG. 4 is a drawing of the apparatus system to carry out the method of the invention.

FIG. 5 is a drawing of the apparatus system to carry out the method of the invention.

FIG. 6 is a drawing of the apparatus system to carry out the method of the invention.

FIG. 7A shows a process of pressing down the cutter on the assembly of sheet of stretchable cuttable material on the defecting device.

FIG. 7B shows a process of pressing down the cutter on the assembly of sheet of stretchable cuttable material on the defecting device.

FIG. 8A shows a process of pressing down the cutter on the assembly of sheet of stretchable cuttable material on the defecting device.

FIG. 8B shows a process of pressing down the cutter on the assembly of sheet of stretchable cuttable material on the defecting device.

FIG. 9 shows a process of pressing down the cutter on the assembly of sheet of stretchable cuttable material on the defecting device, and withdrawing the cutter.

FIG. 10 shows a process of pressing down the cutter on the assembly of sheet of stretchable cuttable material on the defecting device, and withdrawing the cutter.

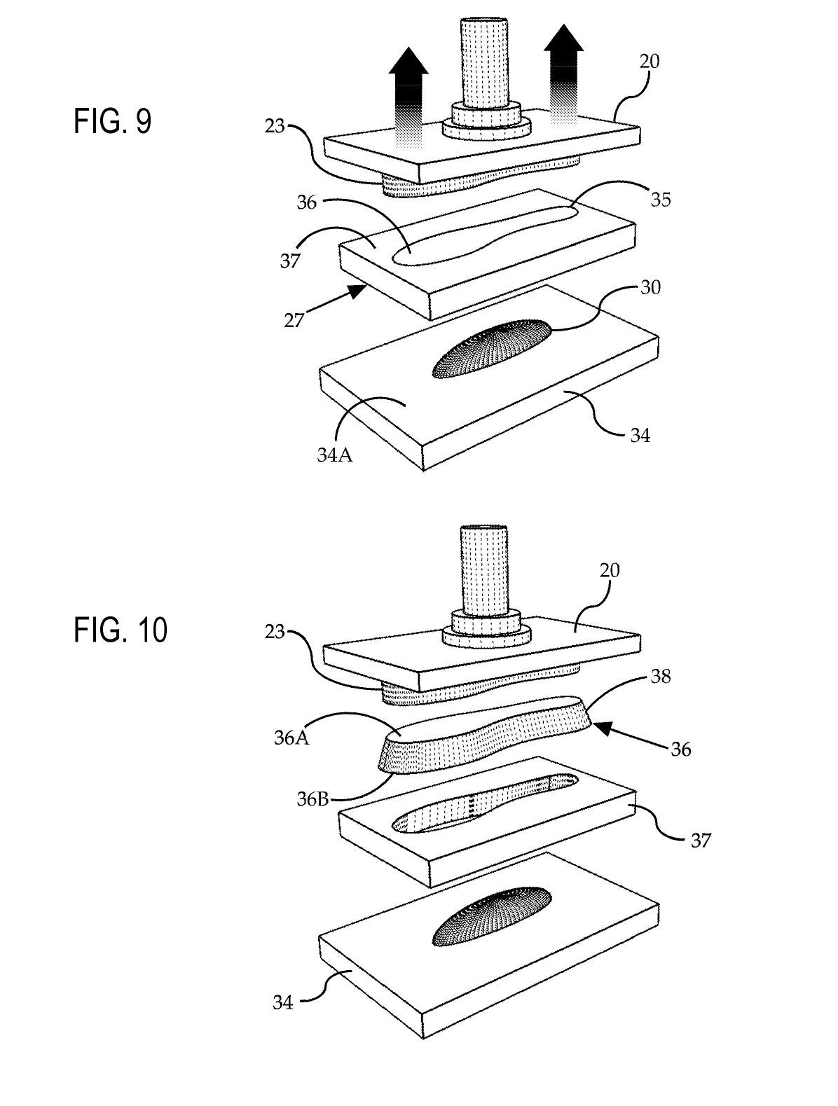

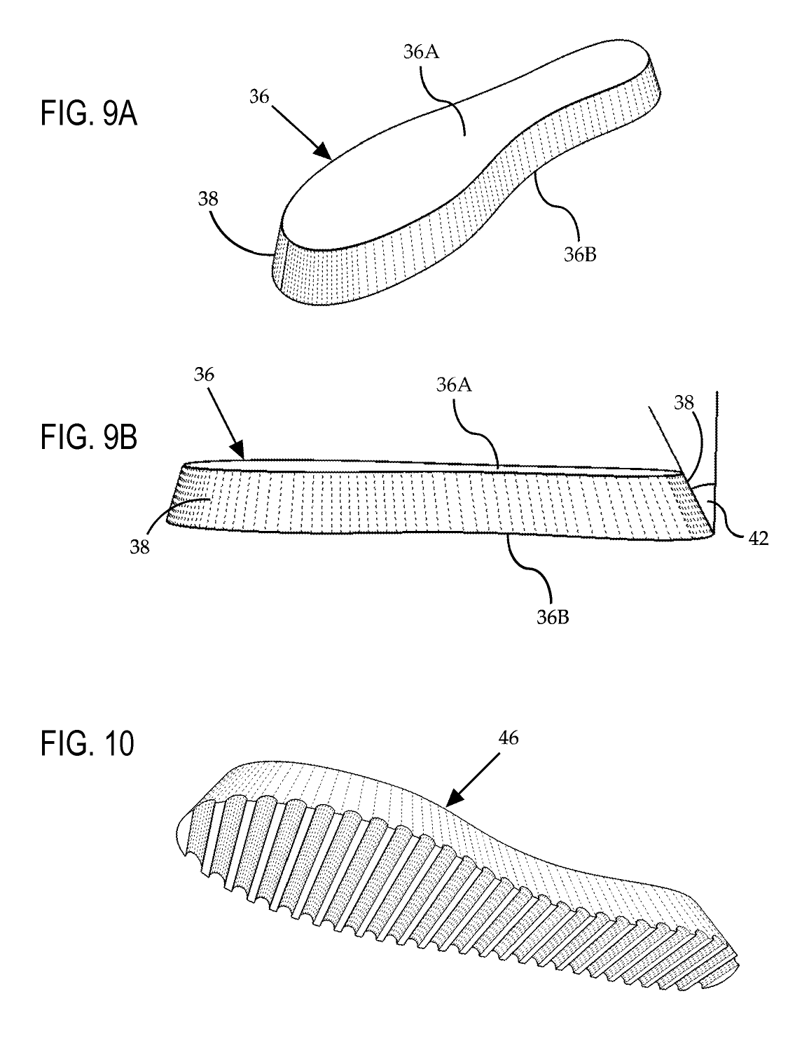

FIG. 9A shows beveled edge shape of cut sheet of material.

FIG. 9B shows beveled edge shape of cut sheet of material.

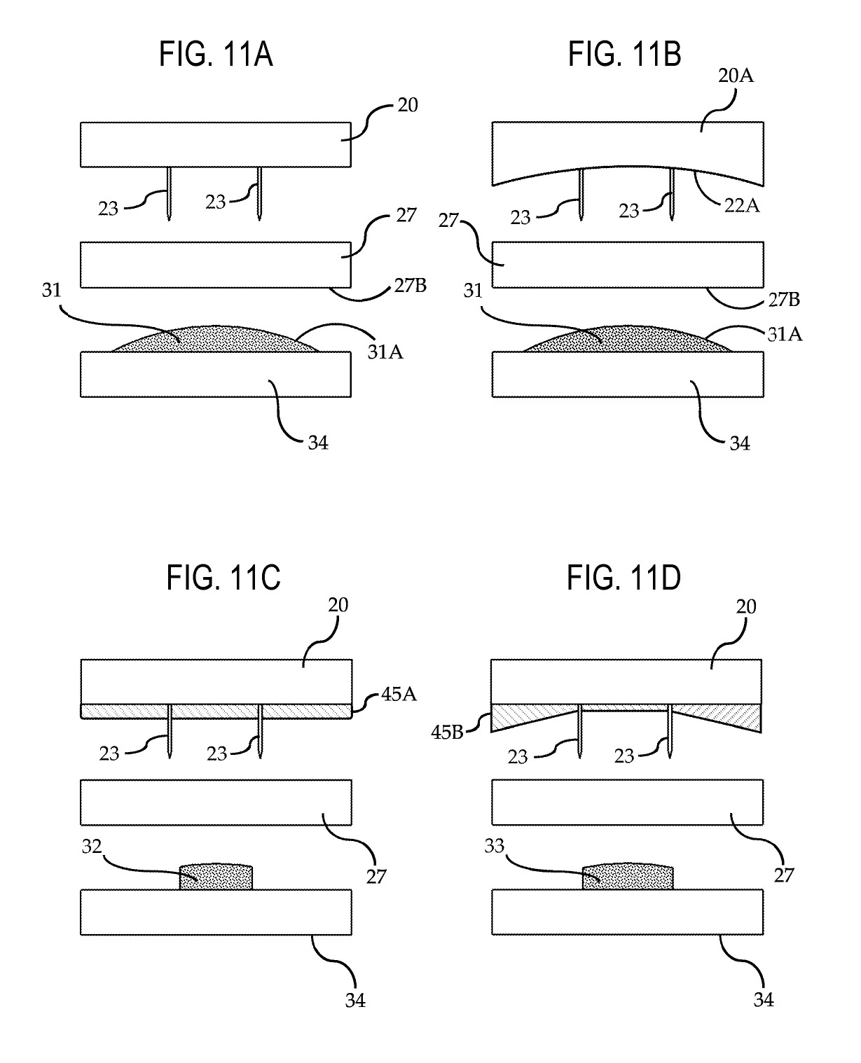

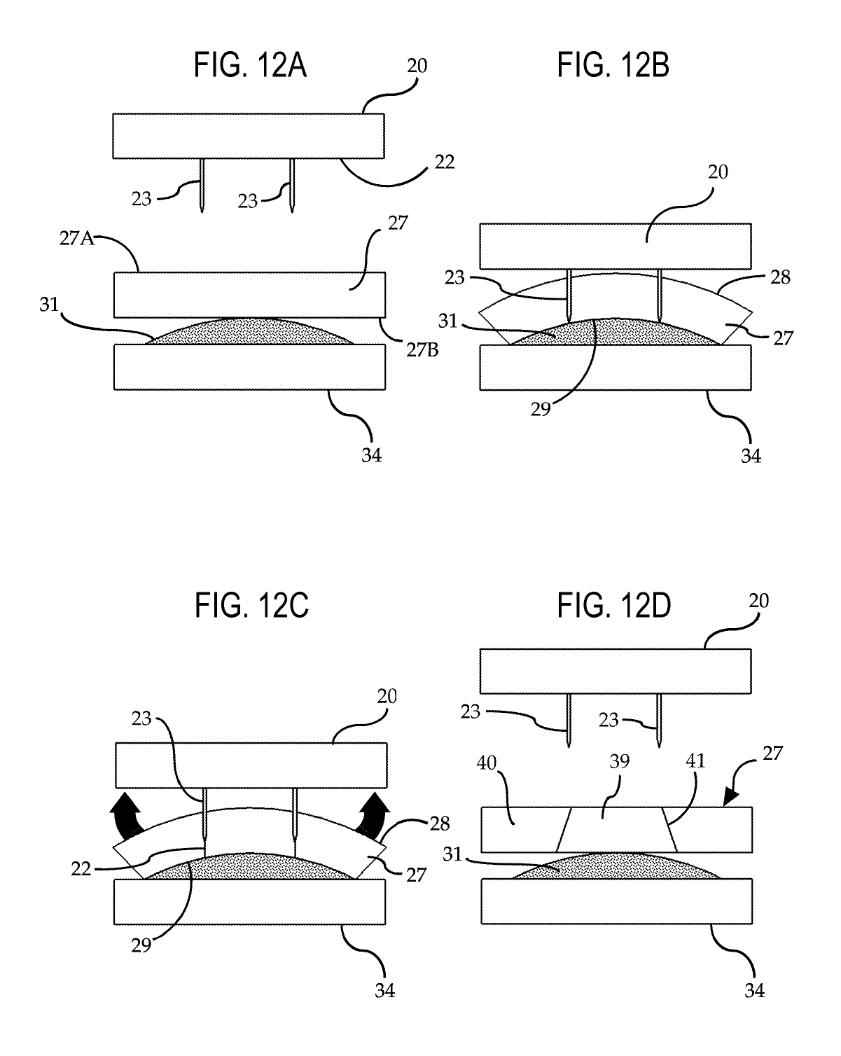

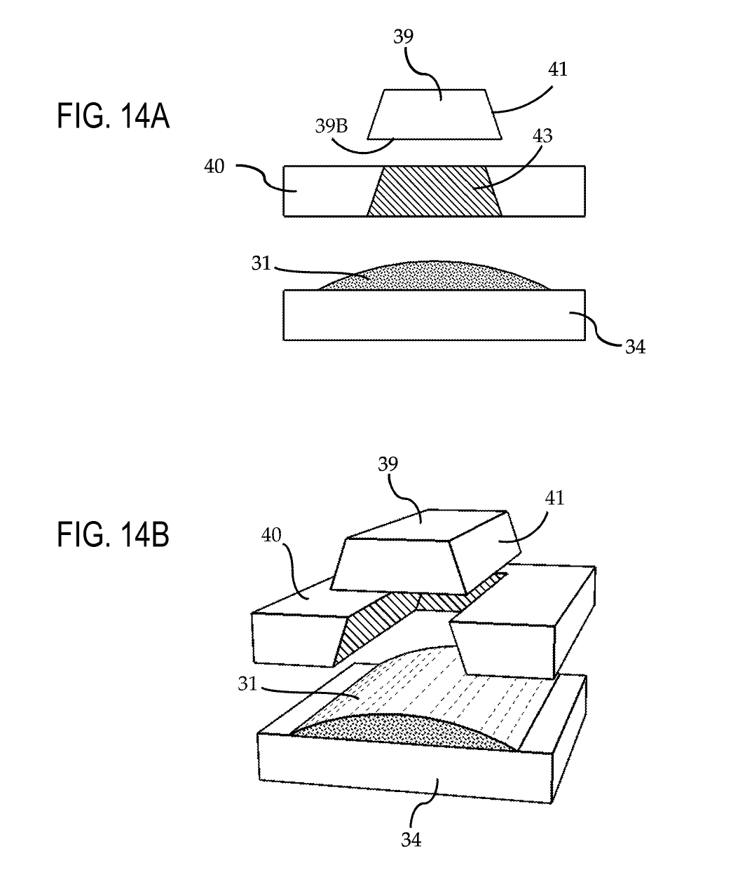

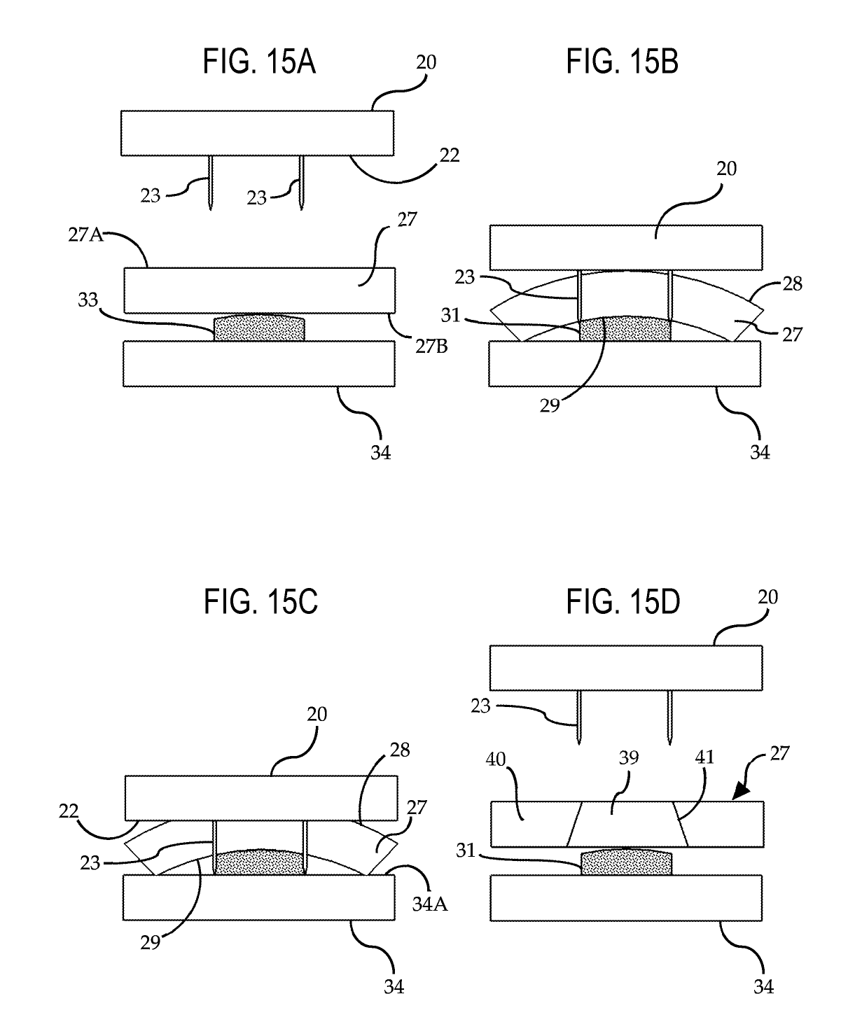

FIG. 10 shows beveled edge shape of cut sheet of material.

FIG. 11A is a drawing of an embodiment of the apparatus system to carry out the method of the invention.

FIG. 11B is a drawing of an embodiment of the apparatus system to carry out the method of the invention.

FIG. 11C is a drawing of an embodiment of the apparatus system to carry out the method of the invention.

FIG. 11D is a drawing of an embodiment of the apparatus system to carry out the method of the invention.

FIG. 12A is a drawing of an embodiment of the apparatus system to carry out the method of the invention.

FIG. 12B is a drawing of an embodiment of the apparatus system to carry out the method of the invention.

FIG. 12C is a drawing of an embodiment of the apparatus system to carry out the method of the invention.

FIG. 12D is a drawing of an embodiment of the apparatus system to carry out the method of the invention.

FIG. 14A shows schematic of production of beveled edge of sheet of stretchable cuttable material with the defecting device.

FIG. 14B shows schematic of production of beveled edge of sheet of stretchable cuttable material with the defecting device.

FIG. 15A shows an embodiment of a process of pressing down the cutter on the assembly of sheet of stretchable cuttable material on the defecting device.

FIG. 15B shows an embodiment of a process of pressing down the cutter on the assembly of sheet of stretchable cuttable material on the defecting device.

FIG. 15C shows an embodiment of a process of pressing down the cutter on the assembly of sheet of stretchable cuttable material on the defecting device.

FIG. 15D shows an embodiment of a process of pressing down the cutter on the assembly of sheet of stretchable cuttable material on the defecting device.

### DETAILED DESCRIPTION OF THE INVENTION

In the present application, “a” and “an” are used to refer to both single and a plurality of objects.

Below is a description of the elements noted in the Drawings.

20—cutter

20A—cutter

21—handle of cutter

22—cutter surface

22A—cutter surface

23—cutting element

24—cutting edge

24A—cutting edge

24B—cutting edge

24C—uncut marking on stretchable cuttable material corresponding to the shape of the cutting element

25—shape defining internal space of the cutting element

26—cutter surface

27—stretchable cuttable material

27A—top side of stretchable cuttable material

27B—bottom side of stretchable cuttable material

28—curved top side of stretchable cuttable material

29—curved bottom side of stretchable cuttable material

30—defecting device

30A—top side of defecting device

31—defecting device

31A—template edge

32—alternative defecting device

33—alternative defecting device

34—surface

34A—top side of surface

35—design cut corresponding to shape of cutting element

36, 39—internal space of stretchable cuttable material corresponding to shape of cutting element

36A—top side of beveled internal space of stretchable cuttable material corresponding to shape of cutting element

36B—bottom side of beveled internal space of stretchable cuttable material corresponding to shape of cutting element

37, 40—excess stretchable cuttable material after cutting with cutting element

38, 41—beveled edge of stretchable cuttable material that is cut with cutting element

41—uncut stretchable cuttable material that is marked to be cut with cutting element

42—angle of the bevel

43—open space after removing stretchable cuttable material with beveled edge

45A—additional material added to cutter surface

In one aspect, the stretchable cuttable material may be any material that is amenable of being stretched and of being cut, and may include resilient material. Such resilient material may include without limitation some type of resilient material, such as foam, rubber, elastomer, plastic, and so forth (including a combination of such materials). Functionally, the resilient material may act as a cushion against impact, or provide insulation to heat, depending on the types and material.

There is no requirement on the height or shape of the sheet of stretchable cuttable material. The variability in height may be aesthetic or may serve a physical function. Regarding the shape of the material, while the presently exemplified shape is shaped as a rectangular sheet of material cut into beveled edge, other designs that use different shape starting material to make any assortment of beveled material is possible. Shapes include oval and circular, various polygons, such as triangles, squares, pentagons, hexagons, heptagons, and so forth, including, dumbbell shapes, other irregular shapes or a mixture of any of these various shapes that can be imagined according to desirability.

There is no requirement on the height or shape of the defecting device. The variability in height may be aesthetic or may serve a physical function. Regarding the shape of the defecting device, while the presently exemplified shape is that of a shoe bottom, other designs that use different shape starting material to make any assortment of beveled material is possible. Varying the height of the defecting device, for example will cause the angle of the created bevel to be steeper.

The defecting device is made with solid material that more stable than the stretchable cuttable material, as the stretchable cuttable material should be made to curve around the defecting device as force is exerted on the stretchable cuttable material around the defecting device. Thus, the defecting device may be made of such solid material as wood, metal, hard plastic, and so forth.

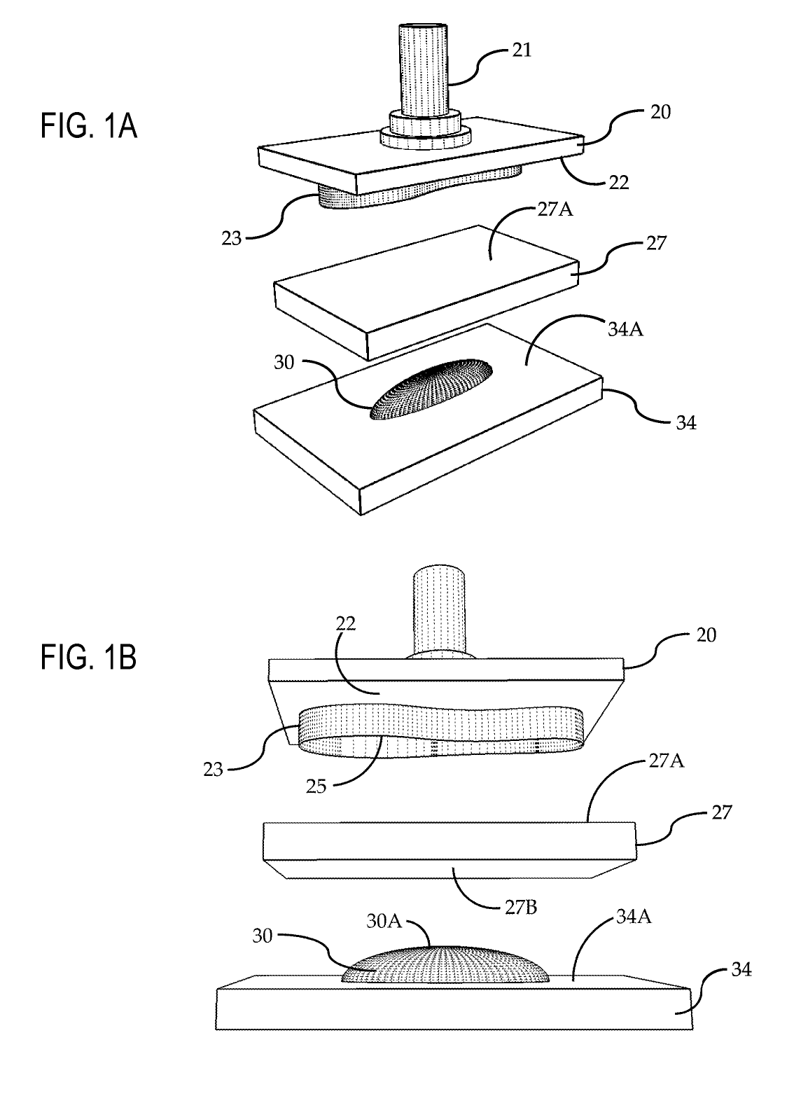

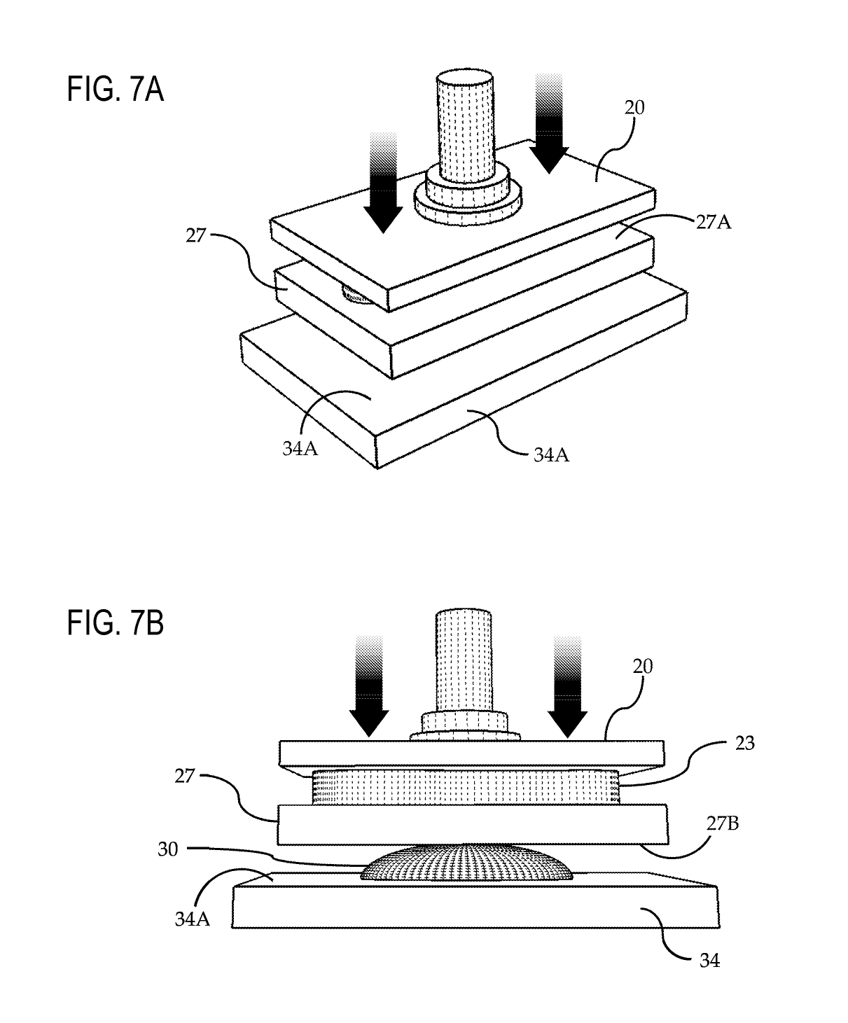

A typically obtained inventive beveled pad structure using the method of the invention is shown in FIGS. 9A, 9B, 10, 14A and 14B. The apparatus for making the beveled pad structure is shown in FIGS. 1A, 1B, 4, 5, 7A, 7B, 8A, 8B, which include the following components. Referring to FIG. 1A. On a surface 34 is provided a defecting device 30, to which is mounted a sheet of stretchable and cuttable material 27. A cutter 20 is also provided with a cutting element 23 extending from the cutter surface 22. Optionally, the cutting element 23 may be positioned substantially perpendicular to the cutter surface 22. In one embodiment, as exemplified in FIG. 11B, the side of the cutter surface 22A from which the cutting element 23 extends from may be not-flat so as to provide greater defect to the sheet of stretchable cuttable material 27 when the cutter 20 is pressed on the sheet of stretchable cuttable material 27 placed over the defecting device 30. Various types and shapes of defecting device 30 and various additional material added to the cutter surface 45A, are also exemplified.

A Process for Making the Stretchable Cuttable Material with Beveled Edge

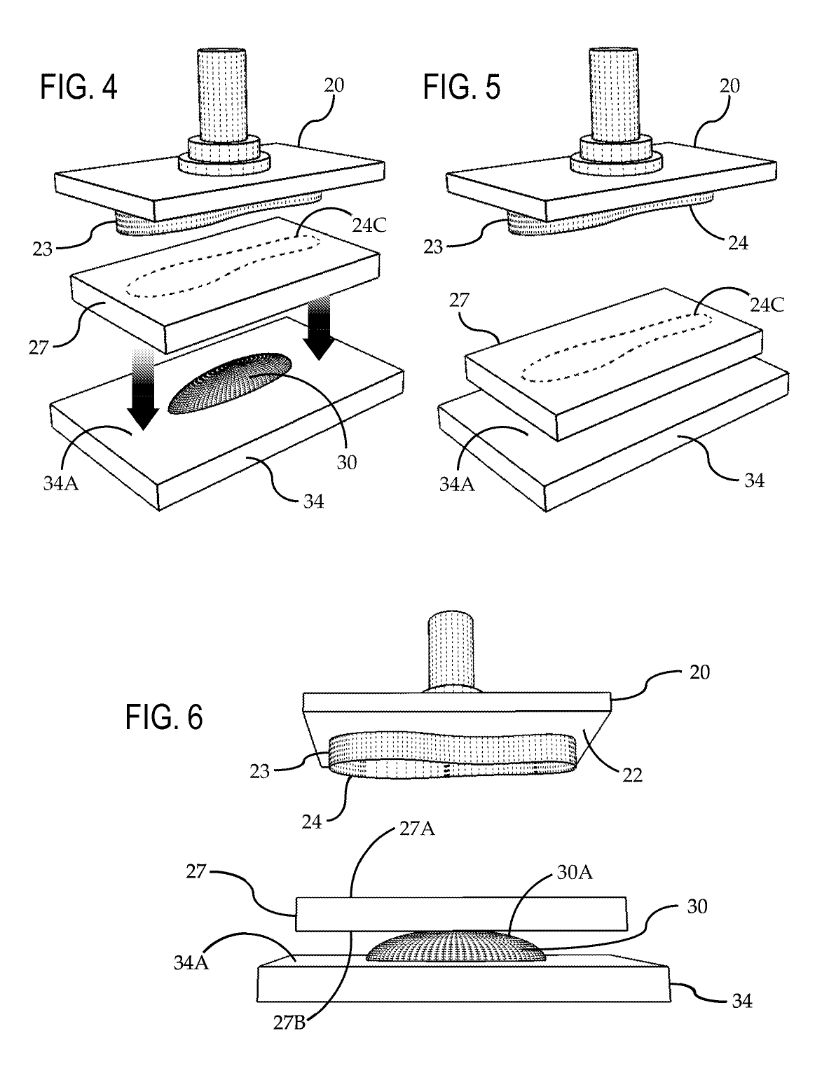

The present invention also relates to a process for making the stretchable cuttable material with beveled edge, such as depicted in FIGS. 4, 5, 6, 7A, 7B, 8A, and 8B. In one exemplified method, the process generally comprises:

(a) placing a defecting device 30 on a surface 34;

(b) mounting a stretchable cuttable material 27 on the defecting device 30;

(c) providing a cutter 20 having a surface 22 and at least one cutting element 23 extending from the surface 22 in a predetermined pattern, where each cutting element 23 has a shape defining an internal space 25, and the internal space is optionally filled with biasing material;

(d) pressing the cutter 20 into the sheet of stretchable cuttable material 27, thereby creating a curvature on the stretchable cuttable material formed around the defecting device to form a defected curved or defected material, and thereby the cutting edge 24 cuts through the curved material thereby forming a cut sheet of stretchable cuttable material comprising a stretchable cuttable material with beveled edge and an excess of stretchable cuttable material, where each stretchable cuttable material with beveled edge has a shape corresponding to the shape of the internal space of its corresponding cutting element;

(e) withdrawing the cutter 20 from the cut sheet of stretchable cuttable material, thereby leaving the cut sheet of stretchable cuttable material with the cut portions of the stretchable cuttable material with beveled edge surrounded by the excess stretchable cuttable material; and

(f) removing the stretchable cuttable material with beveled edge.

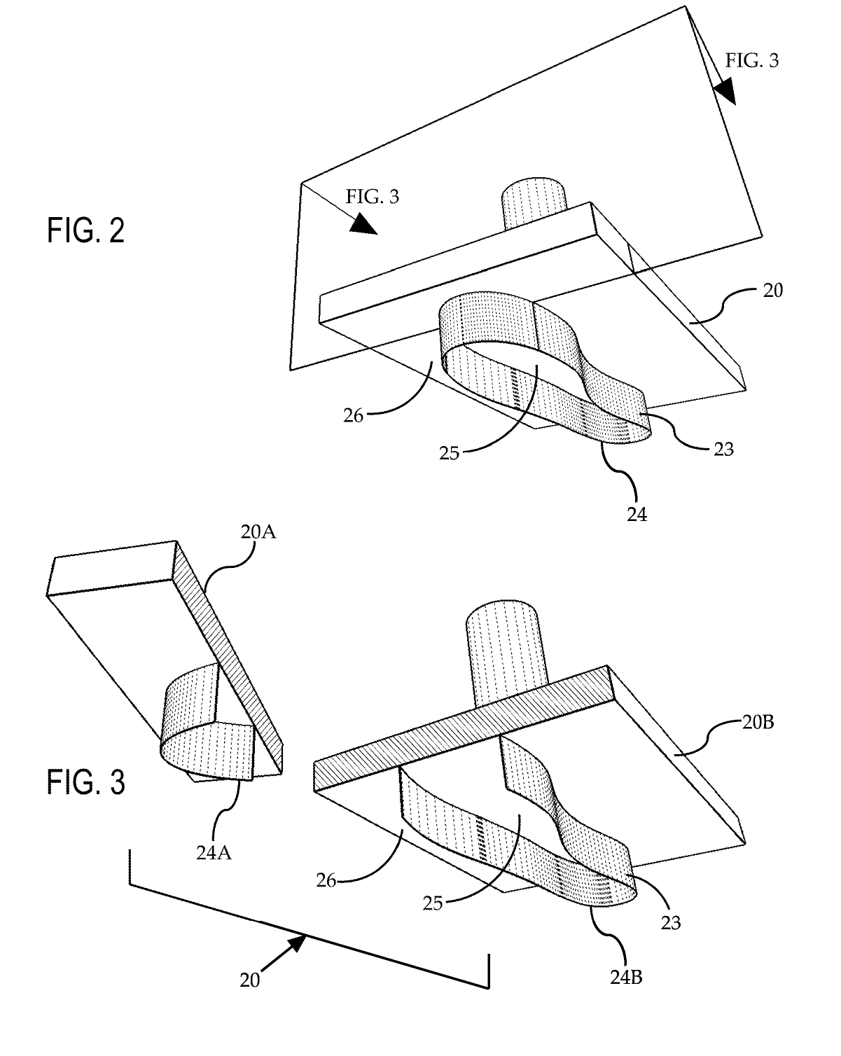

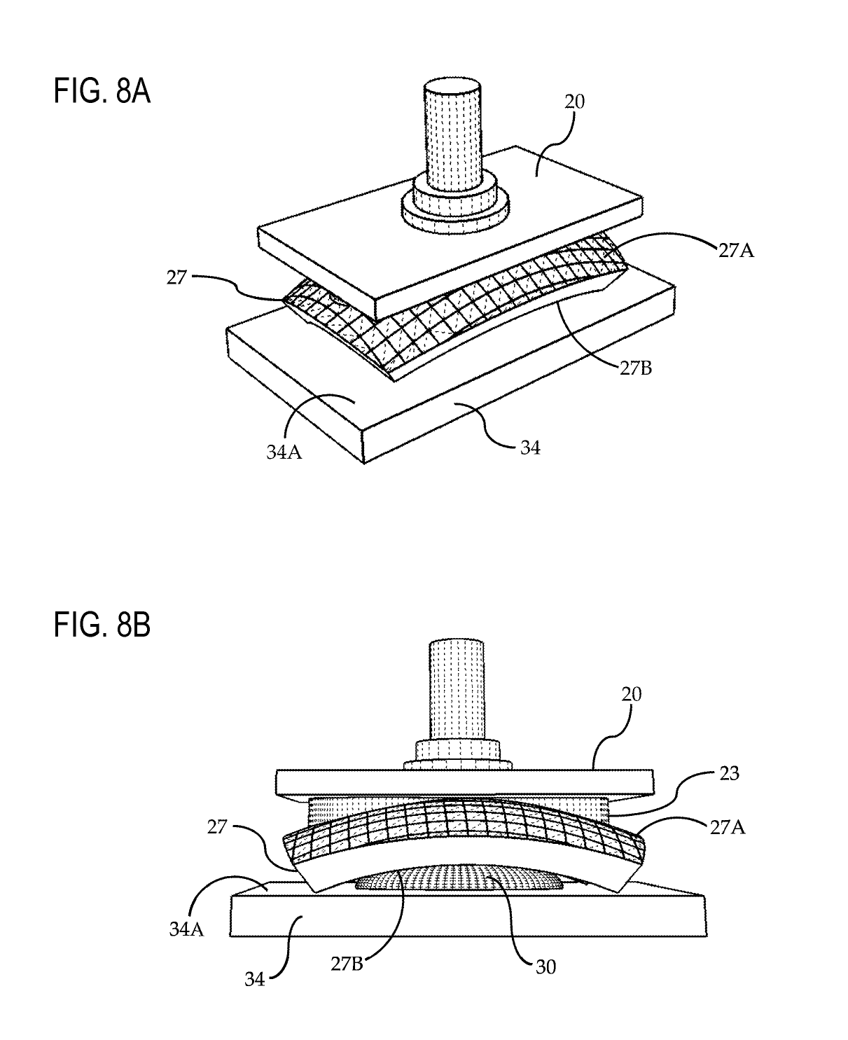

Referring now to the drawings, FIGS. 1 to 15 generally show the process for cutting sheets of stretchable and cuttable materials to form cut sheets of stretchable and cuttable materials. FIGS. 8A and 9B show a sheet of stretchable and cuttable material 27 positioned between a cutter 20 and a defecting device 30. The sheet of stretchable cuttable material shown in FIG. 4 is depicted in solid lines as an uncut sheet, whereas the dashed lines show how the sheet of stretchable cuttable material looks after it has been cut with the cutter in the manner described above. The sheet of stretchable cuttable material may be made of such materials as foam, rubber, elastomer, plastic, and so forth (including any combination of such materials). The material may be selected based on its resilience to impact, heat insulation properties, breathability, weight, ease of use in manufacturing, or any other desirable properties.

The stretchable cuttable material may be cut in a desired and predetermined manner using a cutter, such as cutter 20. The cutter may include a cutting surface 22 for supporting various cutting edges 24 or other structures. The cutting surface may be substantially planar. Alternatively or additionally, the cutting surface may be irregularly shaped or curved if it is desired to create more defect in the sheet of stretchable cuttable material once the sheet of material is placed over the defecting device 30.

It is also contemplated that a plurality of cutting elements 23 may extend from the cutting surface to form a preselected pattern, each cutting element being sharpened at the end used for engaging and cutting materials. Each cutting element is shaped to define an internal space 25 corresponding to the desired shape of cut material.

The various components of the process disclosed herein may be made of any suitable material and may be any size and shape consistent with their functions. The specific embodiments of the process disclosed and illustrated herein are not to be considered in a limiting sense as numerous variations are possible. Ordinal indicators, such as first, second or third, for identified elements in the specification or the claims are used to distinguish between the elements, and do not indicate a required or limited number of such elements, and do not indicate a particular position or order of such elements unless otherwise specifically indicated. The subject matter of this disclosure includes all novel and non-obvious combinations and subcombinations of the various features, elements, functions and/or properties disclosed herein. No single feature, function, element or property of the disclosed embodiments is essential.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. The following examples are offered by way of illustration of the present invention, and not by way of limitation.

Those skilled in the art will recognize, or be able to ascertain using no more than routine experimentation, many equivalents to the specific embodiments of the invention specifically described herein. Such equivalents are intended to be encompassed in the scope of the claims.

1. A pad structure comprising stretchable cuttable material with beveled edge.

2. The pad structure according to claim 1, wherein the beveled edge is present around the entire material.

3. The pad structure, according to claim 1, wherein the structure is a shoe component.

4. A system of components comprising:
a defecting device on a surface;
a sheet of stretchable cuttable material placed on the defecting device on a surface;
a cutter having a surface and at least one cutting element extending from the surface in a predetermined pattern, where each cutting element has a shape defining an internal space, and the internal space is optionally filled with biasing material.

5. The system according to claim 4, wherein the cutting element is positioned substantially perpendicular to the surface of the cutter from which the cutting element extends.

6. The system according to claim 5, wherein the surface of the cutter from which the cutting element extends is not flat.

7. A method for fabricating a stretchable cuttable material with a beveled edge, comprising:
(a) placing a defecting device on a surface;
(b) mounting a stretchable cuttable material on the defecting device;
(c) providing a cutter having a surface and at least one cutting element extending from the surface in a predetermined pattern, where each cutting element has a shape defining an internal space, and the internal space is optionally filled with biasing material;
(d) pressing the cutter into the sheet of stretchable cuttable material, thereby creating a curvature or defect on the stretchable cuttable material formed around the defecting device to form a curved or defected material, and the cutting edge cuts through the curved material thereby forming a cut sheet of stretchable cuttable material comprising a stretchable cuttable material with beveled edge and an excess of stretchable cuttable material, where each stretchable cuttable material with beveled edge has a shape corresponding to the shape of the internal space of its corresponding cutting element;
(e) withdrawing the cutter from the cut sheet of stretchable cuttable material, thereby leaving the cut sheet of stretchable cuttable material with the cut portions of the stretchable cuttable material with beveled edge surrounded by the excess stretchable cuttable material; and
(f) removing the stretchable cuttable material with beveled edge.

8. The method according to claim 7, wherein the cutting edge blade is angled substantially perpendicular to the surface.

9. The method according to claim 7, wherein the curvature or defect on the sheet of stretchable and cuttable material is increased by increasing the curvature of the defecting device.

10. The method according to claim 7, wherein the surface of the cutter from which the cutting element extends is not flat.
